(19) United States
(12) Patent Application Publication
(10) Pub. No.: US 2015/0122691 A1
(43) Pub. Date: May 7, 2015

(54) FLUID DELIVERY SYSTEM

(71) Applicant: DePuy Synthes Products, LLC, Raynham, MA (US)

(72) Inventors: Oren Globerman, Kfar-Shemaryahu (IL); Mordechay Beyar, Caesarea (IL)

(21) Appl. No.: 14/591,295

(22) Filed: Jan. 7, 2015

Related U.S. Application Data
(62) Division of application No. 12/441,743, filed on Jun. 8, 2009, now Pat. No. 8,950,929.
(60) Provisional application No. 60/862,163, filed on Oct. 19, 2006.

(51) Int. Cl. B65D 51/28; A61J 1/20

(52) U.S. Cl. CPC B65D 51/2807; A61J 1/2089; A61J 2001/201; A61J 2001/2048
USPC 206/524.1

(57) ABSTRACT

A fluid delivery system for dispensing a liquid from a sealed container directly into a closed chamber comprises a container containing a liquid component of bone cement and plugged with a plug, and a closed chamber comprising a receiving port for receiving the sealed container, wherein the receiving port is configured to receive the liquid component in direct response to manual insertion of the sealed container through the receiving port using an open loop system.

### RELATED APPLICATION

This application claims the benefit under 119(e) of US 60/862,163 filed 19 Oct. 2006, the disclosure of which is incorporated herein by reference.

### FIELD OF THE INVENTION

The present invention relates to fluid delivery systems, for example, to fluid delivery systems adapted to dispense fluids into mixing chambers.

### BACKGROUND OF THE INVENTION

Mechanical mixers for mixing components to homogeneity are well known. Their applications include, but are not limited to baking, building construction and medicine.

Mixing apparatus for high viscosity mixtures are typically adapted to provide sufficient shear force to continue moving against great resistance. In some cases, the resistance increases during mixing because the viscosity of the mixture increases.

One example of a case where the viscosity of the mixture increases during mixing is preparation of a polymer/monomer mixture. When a polymer and monomer are combined, a polymerization reaction begins. The polymerization reaction increases the average polymer chain length in the mixture and/or causes cross-linking between polymer chains. Increased polymer chain length and/or cross linking between polymer chains contribute to increased viscosity.

Polymerization mixtures are often employed in formulation of bone cement. One common polymer/monomer pair employed in bone cement formulation is polymethylmethacrylate/methylmethacrylate (PMMA/MMA). Because PMMA/MMA bone cements typically set to a solid form, reaction conditions for the polymerization reaction are generally adjusted so that mixing PMMA and MMA produces a liquid phase which lasts several minutes. This is typically achieved by mixing a monomer liquid including MMA and, optionally DMPT and/or HQ, with a polymer powder including PMMA and, optionally Barium Sulfate and/or BPO and/or styrene. Typically, known mixing apparatuses are constructed for use with a liquid polymerization mixture and may not be suitable for mixing of highly viscous cements that have substantially no liquid phase during mixing.

One problem that is typically encountered with some prior art systems derives from the delivery and transfer of the liquid and powder components of the bone cements into the mixing apparatus. These components must be kept separate from each other until the user is ready to mix them. Typically, the dry powder is stored in a flexible bag, while the liquid monomer is stored for shipment and handling in a vial or an ampoule, usually formed from glass; both require opening and pouring into a mixing well prior to mixing. Typically the liquid monomer has a foul odor.

U.S. Pat. No. 6,572,256 to Seaton et al, the disclosure of which is fully incorporated herein by reference, describes a fluid transfer assembly detachably coupled to a mixing vessel. The assembly is designed to dispense a liquid monomer component from a sealed unit in a closed loop operation. The closed-loop operation is facilitated by a vacuum source connected to the mixing vessel though a portal and used as a driving force to suck liquid out of the sealed unit once pierced by a hollow needle.

### SUMMARY OF THE INVENTION

An aspect of some embodiments of the present invention is the provision of a fluid delivery system for dispensing a liquid from a sealed container, e.g. a vial and/or a sealed tube, directly into a closed chamber, e.g. a mixing chamber, using an open loop operation. According to some embodiments of the present invention, the open loop operation includes manual operation and/or gravity. According to some embodiments of the present invention, a receiving port of the closed chamber receives the liquid in direct response to manual insertion of the sealed container through the receiving port using an open loop system. According to some embodiments of the present invention, manual operation is used to directly control the amount of liquid dispensed and/or the rate at which the liquid is dispensed. According to some embodiments of the present invention, the amount of liquid dispensed and the rate of dispensing the liquid can be manually controlled. According to some embodiments of the present invention, the sealed container is detachably coupled to the mixing chamber. According to other embodiments of the present invention, the sealed container is an integral part of the mixing chamber.

An aspect of some embodiments of the present invention is the provision of a sealed container adapted to dispense a contained liquid once engaged onto a receiving port of a closed chamber. According to some embodiments of the present invention, the sealed unit includes a housing adapted to contain a liquid and a seal adapted to seal the liquid contained within the housing. According to some embodiments of the present invention, the seal is configured for piercing and/or rupturing, e.g. by a hollow needle, to open a channel for dispensing the liquid. According to some embodiments of the present invention, the seal is a perforated, weakened or pressure sensitive seal, e.g. have at least one through hole designed to allow leakage under predetermined pressures, which are substantially higher than the nominal lower inner pressure of the container. According to some embodiments of the present invention, the seal is a retractable seal that that can be retracted with respect to the housing so as to push out the liquid through the opened channel, e.g. through the hollow needle piercing the seal. According to some embodiments of the present invention the housing of the sealed unit is adapted for telescopically mounting the housing onto a reception port of the chamber. According to some embodiments of the present invention, the liquid is a liquid component of bone cement.

An aspect of some embodiments of the present invention is the provision of a closed chamber including a receiving port for receiving a liquid from a sealed container. According to some embodiments of the present invention, the chamber is adapted for telescopically engaging the sealed container onto the receiving port. According to some embodiments of the present invention, the receiving port is associated with and/or includes a rupture mechanism for rupturing a seal of the sealed container. According to some embodiments of the present invention, the receiving port includes a base for supporting the seal of the sealed container in place as a user collapses the telescopic engagement between the container and the port. According to some embodiments of the present invention, supporting the seal as the vial is being pushed affects retraction of the seal with respect to the housing of the container and facilitates pushing the liquid out of the container and into the mixing chamber. According to some embodiments of the present invention, the chamber is a mixing chamber for mixing a liquid and powder component of bone cement. According to some embodiments of the present invention, the chamber is predisposed with the powder component of bone cement and the liquid component is added upon demand.

An aspect of some embodiments of the present invention provides a fluid delivery system for dispensing a liquid from a sealed container directly into a closed chamber comprising a container containing a liquid component of bone cement and plugged with a plug, and a closed chamber comprising a receiving port for receiving the sealed container, wherein the receiving port is configured to receive the liquid component in direct response to manual insertion of the sealed container through the receiving port using an open loop system.

Optionally, the plug is configured for retracting into the sealed container during the dispensing.

Optionally, the plug is configured for retracting through the sealed container in response to manually exerted pressure.

Optionally, the plug includes a defined area configured for puncturing, wherein the defined area includes at least one blind hole.

Optionally, the receiving port includes a hollow protrusion to telescopically receive the fluid container.

Optionally, the receiving port includes a supporting element configured to support the plug at a defined height.

Optionally, the closed chamber is a mixing chamber.

Optionally, the mixing chamber is configured for mixing bone cement having a viscosity above 500 Pascal/second.

An aspect of some embodiments of the present invention provides a sealed container comprising a housing comprising an open end and configured for containing a liquid monomer, and a sealing member configured to plug the open end, wherein the sealing member includes a self-rupturing mechanism.

Optionally, the sealing member includes a piercing element and a sealing membrane, wherein the piercing element is distanced from the sealing membrane in the absence of pressure exerted on the sealing member and wherein the piercing element is configured to engage the sealing membrane in the response to predefined pressure exerted on the sealing member.

Optionally, the piercing element is a hollow needle.

Optionally, the self-rupturing mechanism includes a burst valve.

Optionally, the self-rupturing mechanism includes a collapsible orifice.

Optionally, the collapsible orifice opens in response to pressure exerted on the sealing member.

Optionally, the housing is configured for being telescopically mounted onto a reception port of a mixing chamber.

Optionally, the housing includes screw threads configured for advancing the container through a receiving port of a mixing chamber by threaded rotation.

Optionally, the housing is fabricated from a material that is transparent relatively to the liquid monomer.

Optionally, the sealed container comprises scale marks configured for manually monitoring the volume of the liquid.

An aspect of some embodiments of the present invention provides, a mixing chamber comprising a chamber body configured for containing components to be mixed and for mixing the components, a cover configured for sealing the chamber body, and a receiving port integrated onto the cover configured for telescopically engaging a plugged end of a fluid container including a plug and containing a liquid component of bone cement into the receiving port and for manually dispensing the liquid directly into the chamber body.

Optionally, the receiving port includes a channel for directing liquid from the fluid container into the mixing chamber.

Optionally, the receiving port includes a plurality of channels for evenly distributing the liquid throughout the mixing chamber.

Optionally, the receiving port includes a puncture driving mechanism configured to facilitate puncturing of the plug.

Optionally, the receiving port includes a support element for holding the plug in place as the fluid container is manually advanced through the receiving port.

Optionally, the receiving port includes screw threads configured to engage the fluid container with threaded rotation.

Optionally, the mixing chamber is configured for mixing bone cement having a viscosity above 500 Pascal/second.

Optionally, the fluid container is an integral part of the mixing chamber.

Optionally, the mixing chamber comprises a holder configured to prevent undesired backwards movement of the fluid container through the receiving port.

An aspect of some embodiments of the present invention provides a method for dispensing a liquid from a sealed container directly into a closed chamber, the method comprising receiving a plugged end of a fluid container containing liquid though a port of the closed chamber, puncturing the plugged end, and supporting the plugged end in place as the fluid container is manually pushed through the port affecting leakage of the liquid through the punctured plugged end.

Optionally, the fluid container is telescopically received into the port of the closed container.

Optionally, the method comprises dispensing the liquid directly into the closed chamber without exposing the liquid to the environment surrounding the closed chamber.

Optionally, the closed chamber is pre-disposed with a powder component of bone cement and wherein the fluid container is pre-disposed with a liquid component of bone cement.

Optionally, the method comprises channeling the liquid into the mixing chamber.

An aspect of some embodiments of the present invention provides, a method for dispensing a liquid monomer from a sealed container directly into a closed mixing chamber comprising inserting a plugged fluid container containing a liquid monomer into a receiving port of a closed mixing chamber, and puncturing the plugged end of the fluid container by advancing the fluid container through the receiving port.

Optionally, the advancing is by threaded rotation.

Optionally, the method comprises monitoring the amount of liquid dispensed into the chamber.

Optionally, monitoring includes visually monitoring.

Optionally, the method comprises mixing the liquid dispensed in the mixing chamber with a powder component of bone cement.

### BRIEF DESCRIPTION OF THE DRAWINGS

The subject matter regarded is particularly and distinctly claimed in the concluding portion of the specification. Non-limiting examples of embodiments of the present invention are described below with reference to figures attached hereto, which are listed following this paragraph. In the figures, identical structures, elements or parts that appear in more than one figure are generally labeled with a same symbol in all the figures in which they appear. Dimensions of components and features shown in the figures are chosen for convenience and clarity of presentation and are not necessarily shown to scale. For example, the dimensions of some of the elements may be exaggerated relative to other elements for clarity.

FIG. 1A is schematic illustration a fluid container including a sealing member according to some embodiments of the present invention;

FIGS. 1B to 1E are schematic illustrations of additional sealing members that may be used for the fluid container shown in FIG. 1A according to some embodiments of the present invention;

FIG. 2 is a schematic illustration of a chamber with a receiving port for receiving liquid from a sealed fluid container according to some embodiments of the present invention;

FIGS. 3A, 3B, 3C and 3D are isometric, front, top, and section views of fluid delivery system for dispensing a liquid from a fluid container directly into a mixing chamber prior to the onset of dispensing according to some embodiments of the present invention; and

FIGS. 4A, 4B, 4C and 4D are isometric, front, top, and section views of fluid delivery system for dispensing a liquid from a fluid container directly into a mixing chamber after dispensing of the fluid according to some embodiments of the present invention.

It will be appreciated that for simplicity and clarity of illustration, elements shown in the figures have not necessarily been drawn to scale. Further, where considered appropriate, reference numerals may be repeated among the figures to indicate corresponding or analogous elements.

### DETAILED DESCRIPTION OF EXEMPLARY EMBODIMENTS

In the following description, exemplary, non-limiting embodiments of the invention incorporating various aspects of the present invention are described. For purposes of explanation, specific configurations and details are set forth in order to provide a thorough understanding of the embodiments. However, it will also be apparent to one skilled in the art that the present invention may be practiced without the specific details presented herein. Furthermore, well-known features may be omitted or simplified in order not to obscure the present invention. Features shown in one embodiment may be combined with features shown in other embodiments. Such features are not repeated for clarity of presentation. Furthermore, some unessential features are described in some embodiments.

### Exemplary Fluid Container

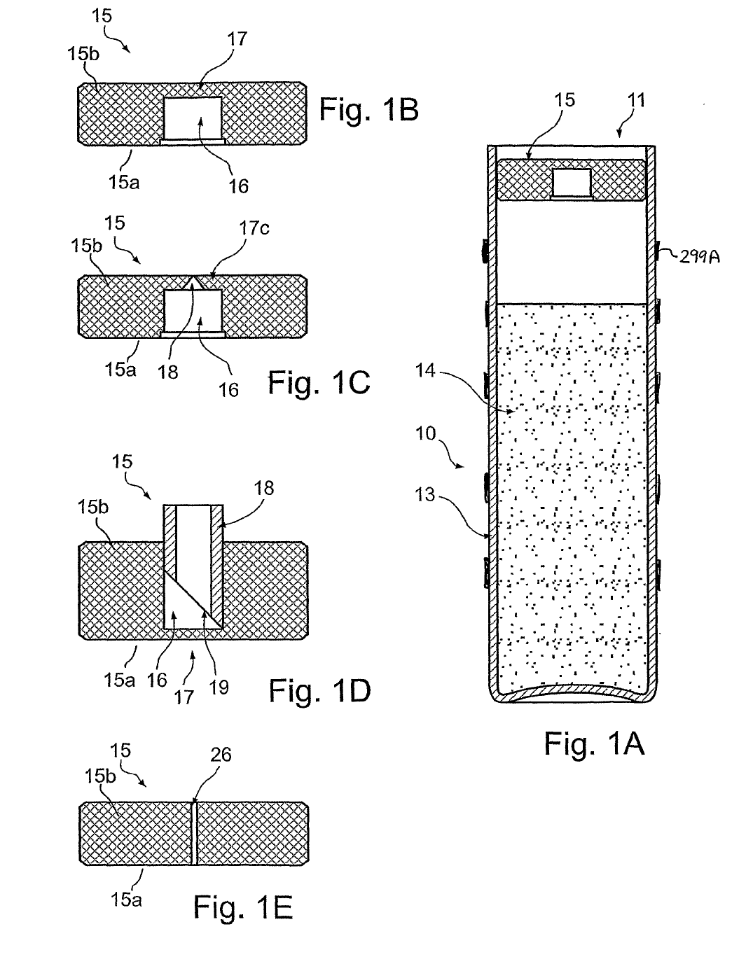

Reference is now made to FIG. 1A showing schematic illustration a fluid container including a slidable seal according to some embodiments of the present invention. According to some embodiments of the present invention, fluid container 10 includes a housing 13, e.g. a tube shaped housing, containing a fluid 14. Typically housing 13 includes an open end 11 that is sealed with a sealing member 15, e.g. a plug and/or plunger. For example, fluid container 10 may be a vial and/or a plugged tube. Optionally, housing 13 may include screw threads 299A on the outer face of the housing.

According to some embodiments of the invention, housing 13 is tubular in shape with a uniform inner cross section along at least part of its length, e.g. a uniform circular cross section. According to some embodiments of the present invention, housing 13 has a volume that can contain between approximately 5 ml to 50 ml, e.g. 10 ml or 20 ml of fluid.

Typically, housing 13 is fabricated from a material that is rigid, transparent and resistant to liquid monomers, e.g. Methylmethacrylate. In some exemplary embodiments, housing 13 is fabricated from glass, plastic material, e.g. Nylon, and/or Stainless steel. In some exemplary embodiments, housing 13 includes scale marks for manually monitoring the volume and/or the mass of the contained fluid. In some exemplary embodiments, the scale marks include numbers and/or quantities.

Typically, fluid 14 contained in fluid container 10 is a liquid, e.g. a liquid monomer. According to some embodiments of the present invention, fluid 14 is an active and/or hazardous material. In some exemplary embodiments, fluid 14 includes a bone cement monomer, e.g. monomer comprising Methylmethacrylate.

According to some embodiments of the present invention, sealing member 15 is a tubular and/or disk shaped component and/or membrane, e.g. a piston and/or plug, that is adapted to slide along the length of housing 13, e.g. half the length and/or the entire length, while maintaining the seal along its perimeter. Typically, the cross section shape and dimensions of sealing member 15 substantially correspond to the inner dimensions of housing 13. Optionally, sealing member 15 may have an outer diameter that is slightly larger than the inner diameter of housing 13 so that mounting and/or sliding into housing 13 may be preformed under a compressive force, e.g. a minimal compressive force. According to some embodiments of the present invention, the sealing member is designed to fit snugly in at least 3 points to prevent trans-axial motion of the sealing member with respect to the housing.

According to embodiments of the present invention, sealing member 15 is fabricated from a material that is resistant and/or compatible with liquid monomers, e.g. Nylon. According to some embodiments of the present invention, at least a portion of sealing member 15 is adapted to be punctured and/or ruptured to facilitate dispensing the contained fluid.

Reference is now made to FIGS. 1B to 1E showing schematic illustrations of sealing members that may be used for the exemplary fluid container shown in FIG. 1A according to some embodiments of the present invention. According to some embodiments of the present invention, sealing member 15 may include a self-rupturing mechanism and/or operate as a valve having a “closed state”, e.g. a pre-ruptured state and an “open state”, e.g. a post-ruptured state. For example, sealing member 15 may function as a burst valve.

In FIG. 1B and FIG. 1C, exemplary sealing members 15 include an inner facing surface 15a and an outer facing surface 15b where inner and outer facing are with respect to housing 13 when the sealing member is positioned in the housing. According to some embodiments of the present invention, sealing member 15 includes at least one blind hole 16, sealed by at least one sealing membrane 17. Typically, sealing membrane 17 is positioned in proximity to the outer surface of sealing member 16. Rupture of sealing membrane 17 may be facilitated by contact with a sharp edge of an object, e.g. a needle piercing the membrane. Typically, sealing membrane 17 is adapted to rupture under a pre-defined compressive force, e.g. a manually exerted pre-determined force.

In FIG. 1C sealing membrane 15 includes a sealing membrane 17 which is weakened in drill 18. In some exemplary embodiments, membrane 15 includes a self-puncturing element, drill 18. In some exemplary embodiments, drill 18 is a conic blind drill that partially advances blind hole 16 into membrane 17. According to some embodiments of the present invention, puncturing results from build up of inner pressure that serves to burst membrane 17, most probably through drill 18.

In FIG. 1D sealing member 15 includes a self-rupturing mechanism. According to some embodiments of the present invention, sealing member 15 includes a blind hole 16, sealing membrane 17 proximal to inner facing surface 15a of sealing membrane 15, and piercing element, e.g. a hollow needle 18 inserted through outer facing surface 15b and including a sharp end 19 facing sealing membrane 17. In some exemplary embodiments, needle 18 is partially projected out of the outer facing surface 15b of sealing member 15 and may have a blunt end 20 facing the outside of housing 13. Typically, sharp end 19 is positioned at a pre-defined distance from sealing membrane 17. Puncturing may be achieved by, for example, pressing the blunt end of needle against a rigid support until contact between the sealing support and the sharp tip of the needle is achieved.

In FIG. 1E, sealing member 15 includes a self-rupturing mechanism in the form of a collapsible channel, perforation and/or orifice 26 penetrating through sealing member 15, e.g. penetrating through inner surface 15a and outer surface 15b. According to some embodiments of the present invention, orifice may be a collapsible orifice that allows leakage only under a predetermined pressure, e.g. a pressure substantially higher than the nominal lower inner pressure of the container. In some exemplary embodiments, orifice 26 is uniform in cross section. Alternatively, orifice may include a converging and/or diverging channel.

According to some embodiments of the present invention, fluid is dispensed from fluid container 10 using an inverted injection mechanism where the plug of the container is pierced by a hollow needle and then is retracted along the housing of the container to force the liquid out though the needle. An exemplary inverted injection mechanism may be similar to the mechanism described in U.S. Pat. No. 1,929,247 to Hein. The disclosure of this patent is fully incorporated herein by reference.

### Exemplary Chamber Including a Receiving Port

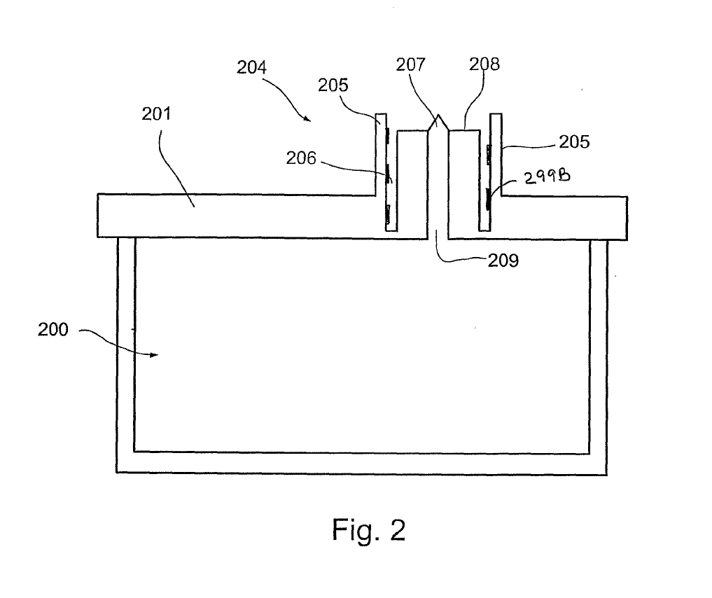

Reference is now made to FIG. 2 showing a schematic illustration of a chamber with a receiving port for receiving fluid from a sealed fluid container according to some embodiments of the present invention. According to embodiments of the present invention, a chamber 200 includes a cover 201 and a receiving port 204. According to some embodiments of the present invention, at least some of the component parts of chamber 200 are resistant to active materials and monomers, e.g. Methylmethacrylate. In some exemplary embodiments, component parts of chamber 200 are fabricated from polyamides, e.g. Nylon and/or polypropylene. Optionally, some component parts of chamber 200 are fabricated from metal, e.g. Stainless Steel.

According to some embodiments of the present invention, receiving port 204 includes a hollow protrusion, an extension and/or wall 205, an inner element 208 within the confines of wall 205 and displaced from the wall, and a gap and/or groove 206 between wall 205 and element 208. According to some embodiments of the present invention, gap 206 is at least wide to permit housing 13, e.g. housing walls, to fit through gap 206. According to embodiments of the present invention, receiving port 204 is capable of telescopically receiving fluid container 10 with in the confines of wall 205 such that the housing of fluid container 10 may fit and slide along wall 204 within gap 206. Typically, wall 205 is tubular having an inner diameter compatible with the outer diameter of fluid container 10 so that fluid container 10 may fit, e.g. snuggly fit, within tubular wall 205. In alternate embodiments of the present invention tubular wall 205 may have an outer diameter compatible with the inner diameter of fluid container 10 so that fluid container 10 may fit over wall 205 and may slide over wall 205. Optionally, wall 205 may include screw threads 299B for receiving the fluid container by threaded motion.

Typically, inner element 208 is tubular in shape, e.g. with a circular cross section, and includes one or more channels 209 directed toward the inside of chamber 200. In some exemplary embodiments, the channel is concentric with inner element 208. According to some embodiments of the present invention channel 209, a hollow tube and/or needle 207 may be positioned within channel 209. For example, a sharp edge of needle 207 may protrude out of chamber 200 so that when fluid container 10 is mounted on receiving port 204, the needle may facilitate rupturing the seal of the fluid container.

According to some embodiments of the present invention, support elements 28 may rigidly support sealing member and/or piston 15 in place while fluid container 10 may be telescopically collapsed through receiving port 204, e.g. while fluid container 10 is made to slide through groove 206. Sliding fluid container 10 through groove 206, while supporting piston 15 in place with support member 208 facilitates increasing the inner pressure of fluid container 10 so that fluid 14 contained within the fluid container will be released.

According to embodiments of the present invention, wall 205, support element 208, and groove 206 may be designed to permit axial sliding of fluid container 10 into gap 206, when inserted into receiving port 204, e.g. sealing member 15 facing the receiving port. In some exemplary embodiments, wall 205, element 208, and/or fluid container 10 may include screw threads so that fluid container 10 may advance into groove 206 with threaded rotation. In an exemplary embodiment of the invention, support element 208 is designed to withhold progress of said piston when the fluid container is pushed towards chamber 22. According to some embodiments of the present invention, support element 208 includes a sharp end 207 that may puncture the plug of the fluid container (e.g. by penetrating a sealing membrane, as described above) so fluids within the vial may flow into passage 29 through said puncture while the vial is pressed into gap 206.

According to some embodiments of the present invention, scale marks and/or quantities may be marked on the fluid container and may correspond to quantities provided by a corresponding powder component of the bone cement. According to some embodiments of the present invention, scale marks and or quantities may be marked on the mixing chamber.

### Exemplary Fluid Delivery System

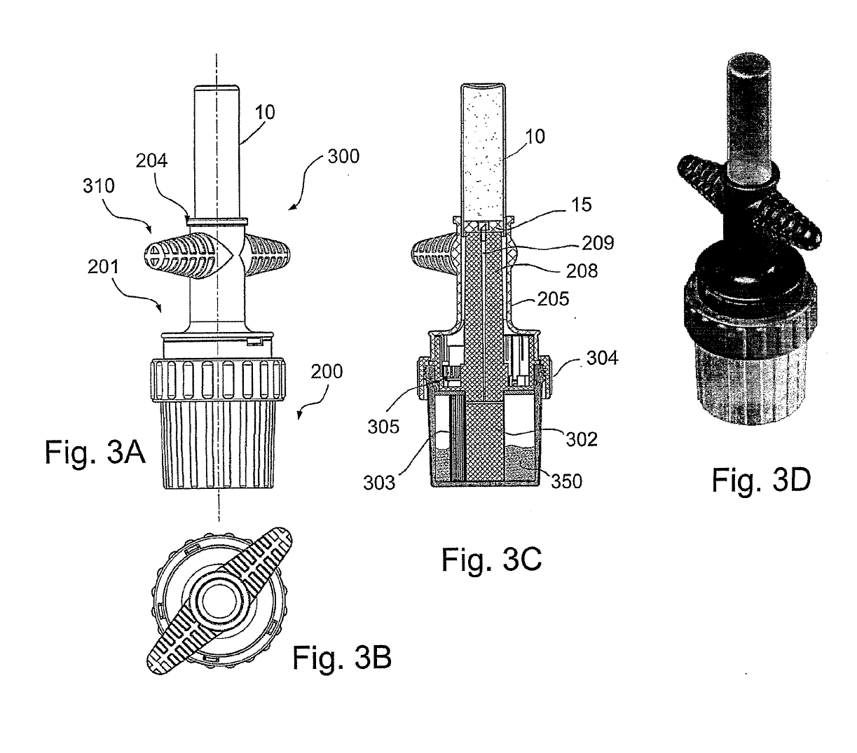

Reference is now made to FIGS. 3A, 3B, 3C and 3D showing isometric, front, top, and section views of an exemplary fluid delivery system for dispensing a liquid from a fluid container directly into a mixing chamber according to some embodiments of the present invention. As shown, mixing apparatus 300 comprises of mixing chamber 200 and cover 201. Typically, cover 201 includes a receiving port 204 and a handle 310. According to embodiments of the present invention, fluid container 10 is positioned within the receiving port so that the sealing member 15 faces the entrance into the receiving port. Chamber 200 is shown to include a component of bone cement 350, e.g. a powder component. According to some embodiments of the present invention the receiving port is concentric with handle 310 and the handle 310 is substantially concentric with the chamber 200. Centering the receiving port through which the fluid container is to be inserted optionally serves to stabilize the system, e.g. mixing chamber together with fluid container.

According to some embodiments of the present invention, mixing chamber 200 may be a mixing chamber for mixing components of bone cement. According to some embodiments of the present invention, mixing chamber 200 may be suitable and/or specifically designed for mixing highly viscous materials in small batches.

According to some exemplary embodiments of the present invention, mixing chamber 200 and cover 201 may be similar to the mixing apparatus described in U.S. patent application Ser. No. 11/428,908 filed on Jul. 6, 2006, the disclosure of which is fully incorporated herein by reference. In some exemplary embodiments, cover 201 incorporates a fastening nut 304 that permits relative rotational movement between cover 201 and not 304, e.g. when handle 310 is manually rotated around a longitudinal axis of receiving port 204. In an exemplary embodiment of the invention, mixing apparatus 300 is a planetary mixer, comprising center mixing arm 302, at least one planetary mixing arm 303 and planetary gear 305. Optionally, planetary gear 305 may be located inside cover 201. Optionally, center mixing arm 302 may be a continuous projection of at least one of the components of cover 201. Typically, mixing arm 305 is rotated as handle 310 is rotated to facilitate the mixing.

According to some embodiments of the present invention, receiving port 204 of cover 201 also includes an extension and/or wall 205, an inner element 208 within the confines of wall 205 and displaced from the wall to form a gap and/or groove 206 as was described in reference to FIG. 2. According to embodiments of the present invention, to initiate operation of the fluid delivery system, the fluid container 10 is telescopically introduced into receiving port 204. According to embodiments of the present invention, prior to dispensing fluid 14 from fluid container 10 into chamber 200, a dry and/or powder component 350 e.g. Polymethylmethacrylate based powder component, is contained in the chamber and fluid container 10 is substantially fully protruding from receiving port 204 as is shown in FIGS. 3A, 3B, 3C and 3D. Prior to the mixing operation of mixing chamber 201, the fluid container 10 is pushed into the receiving port to facilitate puncturing of seal 15 and to push out the fluid from the container toward the mixing chamber through channel 209 as is described herein. Subsequently handle 310 is rotated to facilitate the mixing. One or more channels may be used to direct the liquid into the chamber. For example a plurality of channels may be used to, for example, evenly distribute the liquid throughout the volume of the chamber.

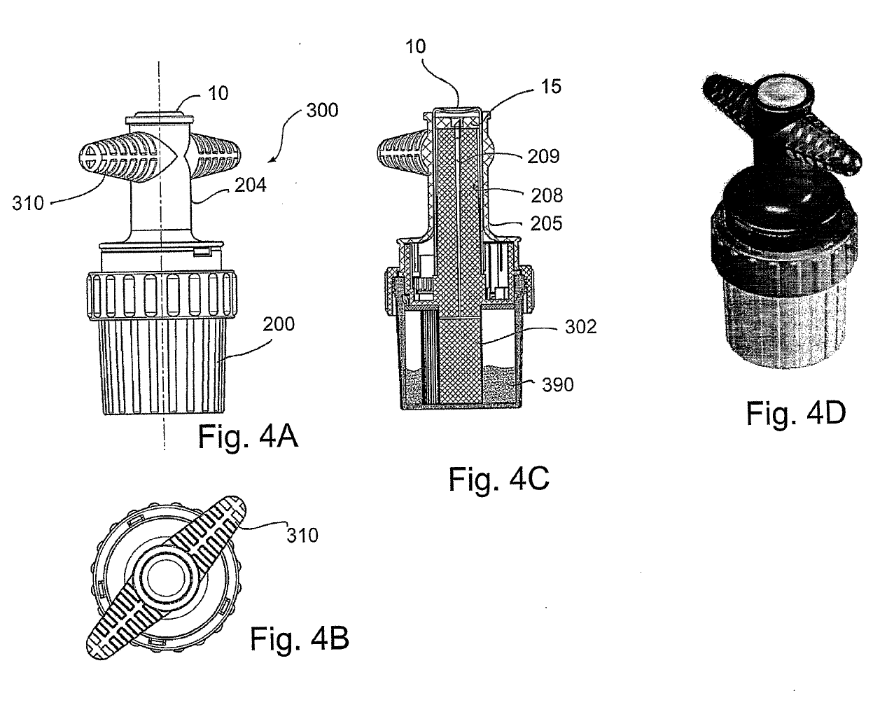

Reference is now made to FIGS. 4A, 4B, 4C and 4D showing isometric, front, top, and section views of fluid delivery system after dispensing of the fluid according to some embodiments of the present invention. Fluid container 10 is shown to be telescopically collapsed into receiving port 204 such that all and/or substantially all the fluid has been dispensed into chamber 200.

During operation a user slides the fluid container through receiving port 204 and uses handles 310 to mix the bone cement 390 contained within the mixing chamber. In some exemplary embodiments, advancing the fluid container into receiving port 204 is by inward threading of the fluid container. In some embodiments of the present invention, all the fluid is dispensed prior to mixing. In other exemplary embodiments, a user may only partially dispense before mixing and or dispense and mix intermittently as required. Optionally, the amount of delivered fluid may be monitored by scales marked on the fluid container and/or on the receiving port. In one exemplary embodiment of the invention, fluid container 10 is transparent relatively to the fluid and/or to piston 15.

Preferably, the inner volume of mixing chamber 32 is large enough to contain all mixing arms, powder component 40 and a desired quantity of liquid component to be injected from vial and/or fluid container 10. Optionally, said desired quantity is introduced into mixing chamber 32 while compressing entrapped air; said introduction is applicative under normal manual forces/moment.

According to some embodiments of the present invention, mixing apparatus 300 may include a holder to prevent undesired backward movement of fluid container 10 through the receiving port. For example, the holder may include threaded portions and/or holding snaps.

According to some embodiments of the present invention, fluid container 10 and mixing apparatus 300 maintain a sealed environment throughout the injection and/or dispensing procedure so that materials, e.g. gaseous, liquid and/or solid materials, cannot leak into and or infiltrate from the surroundings.

According to some embodiments of the present invention, mixing apparatus 300 may include an opening and/or a connection to vacuum source. According to some embodiments of the present invention, mixing apparatus 300 may include a pressure relief valve, which may be operated before or after the dispensing and/or injection procedure.

Optionally, the delivery mechanism is detachably coupled to a mixer element (e.g. a mixer cap/cover, a rotating/static handle, a mixer body, etc.). Alternatively, said delivery mechanism is an integral part of said mixer element. Alternatively, the fluid delivery mechanism and/or the receiving port are separated form the handle and/or mixer element.

The present invention may be equally applicable to all mixing apparatuses, especially though not limited, to bone filler materials mixers. Optionally, said mixing apparatuses are especially designed for mixing highly viscous materials in small batches. In some exemplary embodiment of the invention, “highly viscous” indicates a viscosity of 500, 700 or 900 Pascal/second or lesser or greater or intermediate viscosities. Optionally, this viscosity is achieved within 30, 60, or 90 seconds of onset of mixing. However, under some circumstances the mixing may take a longer time. A small batch may be 100, 50, 25, 15 or 5 ml or lesser or intermediate volumes at the completion of mixing.

In an exemplary embodiment of the invention, the highly viscous material is a bone filler or “bone cement”. Optionally, the bone cement includes a polymeric material, for example polymethylmethacrylate (PMMA). Optionally, the bone cement is one of several types described in one or more of U.S. patent application Ser. Nos. 11/194,411; 11/360,251; and 11/461,072 and U.S. provisional application 60/825,609. The disclosures of all of these applications are fully incorporated herein by reference.

In typical vertebrae treatment procedures, a volume of approximately 5 ml is injected in a single vertebra. It is common to prepare a batch of approximately 8 ml of cement if a single vertebra is to be injected, approximately 15 ml of cement if two vertebrae are to be injected and progressively larger volumes if three or more vertebrae are to be injected. Combination of powdered polymer component and liquid monomer component leads to a reduction in total mixture volume as the polymer is wetted by the monomer. For example, 40 to 50 ml of polymer powder may be mixed with 7 to 9 ml of monomer liquid to produce 18 ml of polymerized cement. In an exemplary embodiment of the invention, a volume of well 252 is selected to accommodate the large initial column of monomer powder, even when a significantly smaller batch of cement is being prepared.

According to various exemplary embodiments of the invention, an inner volume of the mixing chamber 200 may be between 5-150 ml, e.g. 50 or 60. In an exemplary embodiment of the invention, the mixing chamber volume is between 50 to 60 ml, optionally about 66 ml, and is adapted to contain between 10 to 20 ml of mixture. In an exemplary embodiment of the invention, a portion of the inner volume of chamber 32 is occupied by mixing arms 32a and 32b. According to some embodiments of the present invention, the height of the chamber is between 20-100 mm, e.g. 40.

The present invention has been described using detailed descriptions of embodiments thereof that are provided by way of example and are not intended to necessarily limit the scope of the invention. In particular, numerical values may be higher or lower than ranges of numbers set forth above and still be within the scope of the invention. The described embodiments comprise different features, not all of which are required in all embodiments of the invention. Some embodiments of the invention utilize only some of the features or possible combinations of the features. Alternatively or additionally, portions of the invention described/depicted as a single unit may reside in two or more separate physical entities which act in concert to perform the described/depicted function. Alternatively or additionally, portions of the invention described/depicted as two or more separate physical entities may be integrated into a single physical entity to perform the described/depicted function. Variations of embodiments of the present invention that are described and embodiments of the present invention comprising different combinations of features noted in the described embodiments can be combined in all possible combinations including, but not limited to use of features described in the context of one embodiment in the context of any other embodiment. The scope of the invention is limited only by the following claims.

In the description and claims of the present application, each of the verbs “comprise”, “include” and “have” as well as any conjugates thereof, are used to indicate that the object or objects of the verb are not necessarily a complete listing of members, components, elements or parts of the subject or subjects of the verb.

1-8. (canceled)

9. A sealed container comprising:
a housing having an open end and configured for containing a liquid monomer; and
a sealing member configured to plug the open end, wherein the sealing member includes a self-rupturing mechanism having a closed state and an open state;
wherein when the self-rupturing mechanism is in the open state, the liquid monomer flows out of the housing.

10. The sealed container according to claim 9, wherein the sealing member includes a piercing element and a sealing membrane, wherein the piercing element is distanced from the sealing membrane in the absence of pressure exerted on the sealing member and wherein the piercing element is configured to engage the sealing membrane in the response to predefined pressure exerted on the sealing member.

11. The sealed container according to claim 9, wherein the piercing element is a hollow needle.

12. The sealed container according to claim 9, wherein the self-rupturing mechanism includes a burst valve.

13. The sealed container according to claim 9, wherein the self-rupturing mechanism includes a collapsible orifice.

14. The sealed container according to claim 13, wherein the collapsible orifice opens in response to a pressure of the liquid in the housing increasing to a predetermined threshold pressure.

15. The container according to claim 9, wherein the housing is configured for being telescopically mounted onto a reception port of a mixing chamber.

16. The container according to claim 9, wherein the housing includes screw threads configured for advancing the container through a receiving port of a mixing chamber by threaded rotation.

17. The sealed container according to claim 9, wherein the housing is fabricated from a material that is transparent relative to the liquid monomer.

18. The sealed container according to claim 9, further comprising scale marks on the housing configured to allow a user to monitor the volume of the liquid in the housing.

19-38. (canceled)

38. The sealed container according to claim 9, wherein the housing contains liquid monomer.

39. The sealed container according to claim 9, wherein the housing is configured to contain approximately 5 ml to 50 ml of a liquid monomer.

40. The sealed container according to claim 9, wherein the housing has a tubular shape.

41. The sealed container according to claim 9, wherein the housing is fabricated from a rigid material.

42. The sealed container according to claim 41, wherein the housing is fabricated from at least one of glass or plastic.

43. The sealed container according to claim 9, wherein the sealing member is configured to slide along a length of the housing while maintain a seal along a perimeter of the sealing member.
